(19) United States
(12) Patent Application Publication
(10) Pub. No.: US 2003/0142647 A1
(43) Pub. Date: Jul. 31, 2003

(54) Discrete soft handoff in CDMA wireless networks

(76) Inventors: Prathima Agrawal, New Providence, NJ (US); David Famolari, Montclair, NJ (US)

Correspondence Address: Telcordia Technologies, Inc., 445 South Street 1G112R, Morristown, NJ, 07960, US

(21) Appl. No.: 10/062,697

(22) Filed: Jan. 31, 2002

(51) Int. Cl. H04B 7/216

(52) U.S. Cl. 370/331; 370/342

(57) ABSTRACT

Method and system for discrete soft handoff of mobile terminals in a wireless CDMA network. Mobile terminal-base station channels perform soft handoff in a discrete fashion by predicting which reserved channels will be “strong” and “weak” for CDMA data frame transmission. At least one of the strong channels is included in the active set of handoff legs used to transmit the CDMA data frame, and the invention transmits the CDMA data frame only through channels within the active set.

### FIELD OF THE INVENTION

The present invention generally relates to wireless communication networks. More specifically, this invention relates to the soft handoff of mobile terminals in wireless Code Division Multiple Access (CDMA) networks.

### BACKGROUND OF THE INVENTION

Modern wireless networks commonly employ CDMA techniques to communicate information between a mobile terminal and base station. Modulating information using CDMA techniques provides an advantage over other modulation methods because CDMA techniques enable multiple base stations to simultaneously use the same frequencies or channel space to communicate information. Thus, CDMA techniques permit channel overlap between base stations, which has a number of significant advantages in wireless communication systems, including the reduction of interference between mobile terminals and base stations, the exploitation of wireless network multipath components, and the simultaneous modulation and demodulation of information on multiple channels with multiple base stations.

Soft handoff is one method that uses these advantages of CDMA techniques to reduce data error and increase the quality of service for wireless CDMA networks. Soft handoff is a steady-state condition wherein a mobile terminal communicates identical information with a plurality of base stations simultaneously. Soft handoff increases transmission and reception diversity at the mobile terminal and mobile switching center of the wireless CDMA network, thereby increasing information capacity and quality of service while reducing the requisite signal-to-noise power ratio necessary to communicate information. Soft handoff typically exists throughout a mobile terminal's network connection; nonetheless, the plurality of base stations that communicate with the mobile terminal may change as the mobile terminal physically changes location, thereby requiring the mobile terminal to switch the base stations with which it communicates.

This prior art soft handoff method employs continuous communication of redundant CDMA data frames via a plurality of mobile terminal-base station network connections. The plurality of mobile terminal-base station network connections, also known as handoff legs, communicate identical redundant information between the base station network and the mobile terminal. The redundant information communicated via the plurality of handoff legs is aggregated or selected at the mobile terminal or the switching center to generate a “best” or recovered CDMA data frame that is treated as the actual CDMA data frame received by the mobile terminal or base station network, respectively. Thus, although one or more of the redundant CDMA data frames received at the mobile terminal or mobile switching center via the plurality of handoff legs may be weak, the “best” CDMA data frame created by frame aggregation or frame selection is superior to those individual redundant CDMA data frames, thereby providing superior performance for communications between the mobile terminal and the base station network.

In order to implement soft handoff within a wireless CDMA network, a mobile terminal and the plurality of base stations it communicates with must perform certain functions in order to maintain the plurality of mobile terminal-base station network connections included as handoff legs. First, the mobile terminal must receive multiple base station transmissions on the forward legs from the base station to the mobile terminal, and then aggregate or select these transmissions to recover the information sent by the plurality of base stations. This aggregation or selection reduces the information error rate and increases the quality of service for the mobile terminal. Thus, the base stations must use identical CDMA symbols to modulate information and synchronize their transmissions to the mobile terminal on the forward legs for the mobile terminal to accurately aggregate or select and demodulate the transmissions received from the base stations.

In addition, the plurality of base stations receive multiple mobile terminal transmissions on the reverse legs from the mobile terminal to each base station. Base stations receive a mobile terminal's transmission by listening to a reverse channel. Each mobile terminal in a CDMA system radiates energy outward using a channel code determined by unique code or ID for that mobile terminal. A particular mobile terminal's reverse channel is thus distinguished from other mobile terminals' reverse channels because it uses its own unique code (like a serial number) to code the information. Thus when mobile channels transmit, they simply radiate information using this code. Base stations that are in the area and are properly informed of this unique mobile terminal code can then listen in on this channel and decode the information, Thus transmission from a mobile terminal to a specific base station or a set of base stations involves letting the base stations know what the unique mobile terminal code is, so that these base stations can listen to that mobile terminal. A mobile switching center aggregates or selects appropriate transmissions from the multiple transmissions received by the base stations in order to reduce the error rate and maintain a sufficient quality of service. By performing selection and aggregation functions that select or aggregate “good” CDMA data frames and reject “poor” CDMA frames from the redundant received CDMA data frames, soft handoff takes advantage of signal diversity and redundancy to create a “best” CDMA data frame which is superior to each individual received CDMA data frame. Generation of such a best CDMA data frame via selection and aggregation functions provides a number of benefits for wireless CDMA communication including lower signal-to-noise ratios, reduction in the requisite transmitter power, reduction in interference, and seamless coverage of mobile terminal communications. Thus, the best CDMA data frame created via selection and aggregation is at least equal to, if not superior to, each individual CDMA data frame, thereby causing better performance.

This better performance comes at a price, however, which is the processing penalty incurred at both the mobile terminal and the mobile switching center to select or aggregate good CDMA data frames, while rejecting poor CDMA data frames, in order to create a best CDMA data frame. Thus, the selection and aggregation functions necessary to support soft handoff increase the processing overhead at both the mobile terminal and the mobile switching center and require additional power consumption necessary to perform the selection and distribution functions to select from and transmit the redundant frames. Furthermore, the implementation of the selection and aggregation functions necessary to create a best CDMA data frame may have an adverse impact on certain wireless network architectures. In particular, for certain network architectures, implementation of the requisite selection and aggregation functions at a particular network location may be difficult or undesirable. For these architectures, the advantages of prior art CDMA soft handoff systems may not overcome the drawbacks of implementing such a system. In summary, the prior art continuous soft handoff method described above involves the simultaneous and continuous communication of redundant CDMA frames along a plurality of handoff legs. The multiple redundant received CDMA data frames are selected or aggregated using CDMA data frame selection and aggregation processes, respectively, in order to create a best CDMA data frame. Although the selection and aggregation processes are ultimately the source of the benefits of soft handoff, they also cause additional processing overhead, power consumption, and network architecture problems that are undesirable, and sometimes insurmountable, in certain network architectures.

### SUMMARY OF THE INVENTION

These and other deficiencies in the prior art continuous soft handoff methods are addressed by the present invention, which provides for discrete soft handoff in CDMA wireless networks, wherein the forward leg or link from a base station to a mobile terminal involves discrete soft handoff via selective transmissions and the reverse leg or link from a mobile terminal to a base station involves discrete soft handoff via selective forwarding. In contrast to prior art continuous soft handoff systems, the present invention includes a discrete soft handoff system that predicts which of the plurality of forward and reverse handoff legs will be “strong” channels for the next CDMA frame transmission and which of the plurality of forward and reverse handoff legs will be “weak” channels for the next CDMA frame transmission. The present invention is then able to transmit the next CDMA data frame over one or more of the “strong” legs, while not transmitting the next CDMA data frame over one or more of the “weak” legs. Thus, although the plurality of forward and reverse handoff legs remain in a reserved state throughout soft handoff, in the sense that these channels remain reserved exclusively for the soft handoff of the mobile terminal, CDMA data frames are actively transmitted using only those strong handoff legs in the active transmission set.

It should be understood that the present invention is a discrete soft handoff method in that only one or more of the plurality of handoff legs is in an active or communicating state for any particular CDMA data frame transmission, even though one or more handoff legs remain in a reserved state. Thus, the present invention is discrete in the sense that only a subset of those reserved handoff legs is actually active for any particular CDMA data frame transmission. In contrast, in the prior art continuous soft handoff systems, every reserved handoff leg is in an active state for every particular CDMA data frame transmission, and there is no ability to identify only those strong handoff legs that should be used to transmit any particular CDMA data frame. Thus, the word “continuous” is used in the sense that known soft handoff methods use every reserved handoff leg to communicate every CDMA data frame. In contrast, the word “discrete” is used in the sense that the present invention uses a subset of those reserved handoff legs to communicate any particular CDMA data frame. Both the prior art continuous soft handoff method and the present invention maintain a steady-state communication link between the base station network and mobile terminal throughout the soft handoff of the mobile terminal.

It should also be understood that the terms “strong” and “weak” are not absolute, but rather refer to the relative strength of reserved handoff legs that may be used for soft handoff of a mobile terminal. Thus, a strong handoff leg is a handoff leg whose channel strength is greater than that of another handoff leg. Similarly, a weak handoff leg is a handoff leg whose channel strength is weaker than that of another handoff leg. In addition, because the terms “strong” and “weak” are relative terms that refer to the marginal signal strength of different handoff legs, a single handoff leg may be both strong and weak, in the sense that the handoff leg may have a channel strength that is stronger than some handoff legs but weaker than other handoff legs. Therefore, the method of the present invention, wherein strong and weak handoff legs are identified and then at least one strong handoff leg is used for soft handoff of a mobile terminal, may be more appropriately thought of as a ranking system, wherein the relative channel strengths of different handoff legs are estimated. Those handoff legs with higher rankings, and hence stronger channel strengths, are preferred when performing soft handoff, whereas those handoff legs with lower rankings, and hence weaker channel strengths, are disfavored when performing soft handoff.

By estimating or determining which handoff legs are strong and weak before CDMA data frame transmission and then transmitting CDMA data frames via at least one strong leg, the present invention reduces the burden to select and aggregate redundant CDMA data frames via selection and aggregation processes, while still producing a best CDMA data frame that is substantially identical to that produced under the prior art continuous soft handoff method. This reduces the processing overhead, power consumption, and network architecture difficulties associated with prior art continuous soft handoff systems, while maintaining its benefits. This is true because soft handoff of a mobile terminal via only strong legs does not reduce soft handoff performance in any significant fashion, as those received CDMA data frames communicated over weak legs would likely not have been selected as the best CDMA data frame or would not have significantly contributed to the aggregation that produces the best CDMA data frame.

In other words, CDMA data frames sent via weak legs would not have been selected as the best CDMA data frame by a CDMA data frame selection process. Similarly, CDMA data frames sent via weak legs would not have significantly contributed to the total aggregation of all CDMA data frames in a CDMA data frame aggregation process. Thus, by performing discrete soft handoff by actively transmitting a CDMA frame using an active subset of one or more strong legs from the reserved set of total handoff legs, the processing overhead, power consumption, and network architecture difficulties associated with prior art soft handoff using both weak and strong legs are avoided at little or no loss in performance. As a result, the present invention still incorporates the benefits of soft handoff by using a plurality of handoff legs to handoff the mobile terminal, and yet alleviates the burden of data selection and aggregation, and its negative effects associated with prior art continuous soft handoff methods.

In addition to reducing the processing overhead, power consumption, and network architecture difficulties associated with prior art continuous soft handoff, discrete soft handoff has a number of other beneficial effects. Of particular significance, the present invention reduces interference attributable to transmission over weak legs that occur in prior art continuous soft handoff systems. The transmissions that occur over weak legs are eliminated, thereby reducing the overall transmission interference attributable to multiple handoff legs. Further, the present invention is flexible and may be used in a variety of network architectures and circumstances. For instance, discrete soft handoff may be configured or implemented to transmit CDMA data frames only via the strongest handoff leg, thereby performing soft handoff by communicating each CDMA data frame using only one handoff leg. This implementation eliminates any need to perform either selection or aggregation because only one handoff leg is required per CDMA frame for soft handoff, thereby greatly simplifying the processing and power requirements to perform soft handoff.

The present invention also provides a flexible method to dynamically determine or predict strong and weak handoff legs. The present invention is both dynamic, in that it predicts strong and weak legs for each individual CDMA data frame, and flexible, in that a plurality of factors including the signal-to-interference ratio, transmitted and received signal strengths, distance, cell load, and propagation delay can be used to determine which handoff legs are strong and which are weak. Thus, the prediction of strong and weak legs includes a plurality of flexible factors such as those above, thereby allowing the predictive mechanism to be tailored to individual network architectures.

In accordance with the present invention, a mobile terminal collects signal attributes from the various hand-off legs, such as the Signal-to-Interference for a leg and the signal strengths. In one illustrative embodiment of the present invention, the mobile terminal itself then performs the analysis of these attribute values, forming predictions and classifying the handoff legs as either strong or weak. The mobile terminal then transmits that classification to the systems mobile switching center (MSC) and marks the appropriate serving base station (SBS) field of packets that it transmits to reflect this decision. In a second illustrative embodiment, each mobile terminal passes the collection of signal attributes to the mobile switching center (MSC) which then itself performs the analysis, prediction, and classification functions.

### BRIEF DESCRIPTION OF THE DRAWINGS

The foregoing and other features of the present invention will be more readily apparent from the following detailed description and drawings in which:

FIG. 1 is a diagram illustrating a CDMA soft handoff system in accordance with the present invention depicting discrete soft handoff within sectors as well as discrete soft handoff between mobile terminals;

FIG. 2A is a flow chart of the discrete handoff process in accordance with one illustrative embodiment of the invention;

FIG. 2B is a flow chart of the discrete handoff process in accordance with a second illustrative embodiment of the invention;

FIG. 3 is a flowchart of the handoff leg signal strength measurement process for the embodiment of FIG. 2A;

FIG. 4 is a flowchart of the handoff leg signal strength prediction process for the embodiment of FIG. 2A; and

FIG. 5 is a flowchart illustrating the handoff leg active set selection process for the embodiment of FIG. 2A.

### DETAILED DESCRIPTION OF THE PREFERRED EMBODIMENTS

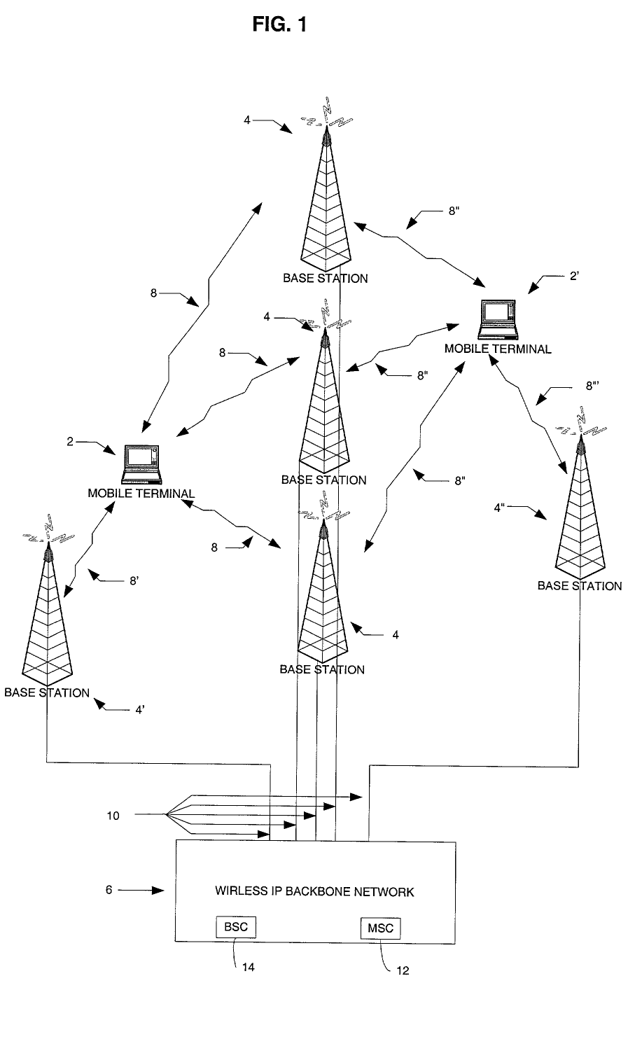

Turning now to FIG. 1, therein is shown a diagram illustrating a CDMA soft handoff system in accordance with the present invention depicting Discrete Soft Handoff within sectors. A plurality of mobile terminals 2 and 2′ are in a steady-state soft handoff condition with a plurality of base stations 4, 4′ and 4″ via their handoff legs 8, 8′, 8″, 8′″. In FIG. 1 handoff legs between base stations, also known as handoff between sectors, is represented via handoff legs, 8, 8′, 8″, and 8′″. The base stations 4, 4′ and 4″ are connected to the wireless backbone network 6 via wireless backbone network connections 10. The wireless backbone network 6 includes the appropriate mobile switching center (MSC) 12 and base station controllers (BSCs) 14 necessary for base stations 4, 4′ and 4″.

Each mobile terminal 2 and 2′ is in soft handoff via handoff legs 8, 8′, 8″, and 8′″ with certain base stations. The three base stations 4 communicate with mobile terminal 2 via the three separate handoff legs 8 between the base stations 4 and mobile terminal 2. The three base stations 4 also communicate with mobile terminal 2′ via the three separate handoff legs 8″ between the base stations 4 and mobile terminal 2′. In addition, base station 4′ communicates with mobile terminal 2 via the handoff leg 8′, and base station 4″ communicates with mobile terminal 2′ via the handoff leg 8′″. Thus, mobile terminal 2 is in soft handoff with the four base stations 4 and 4′ via its four handoff legs 8 and 8′. Similarly, mobile terminal 2′ is in soft handoff with the four base stations 4 and 4′ via its four handoff legs 8″ and 8′″. Communications between the mobile terminals 2 and 2′ and the wireless IP backbone network 6 take place via wireless backbone network connections 10 between the wireless backbone network 6 and the base stations 4, 4′ and 4″.

As a mobile terminal moves throughout the wireless CDMA network, those base stations with which the mobile terminal communicates during soft handoff change according to the channel strength of each handoff leg. When the channel strength of a handoff leg drops below a certain threshold value, that leg may be dropped because it is no longer strong enough to support soft handoff. Similarly, when the channel strength of a prospective handoff leg rises above a certain threshold value, that leg may be added as a handoff leg because it is now strong enough to support soft handoff.

For instance, mobile terminals 2 and 2′ can be viewed as a single mobile terminal that has migrated through the wireless CDMA network. Under this view, a single mobile terminal may be geographically located within the wireless CDMA network as mobile terminal 2, but subsequently migrate through the CDMA network to become mobile terminal 2′. As this migration occurs, the handoff leg 8′ between the mobile terminal 2 at its original location and the base station 4′ will be dropped, and the handoff leg 8′″ between the mobile terminal 2′ at its new location and the base station 4″ will be added. The handoff legs 8 and 8″ are in fact the same handoff legs, having been maintained as the mobile terminal 2 at its original location migrates to become mobile terminal 2′ at its new location.

The advantage of soft handoff is that the plurality of handoff legs provides transmission and reception diversity, such that the communications between a mobile terminal and the wireless CDMA network remains satisfactory as the mobile terminal migrates through the wireless CDMA network. Thus, as the mobile terminal 2 becomes the mobile terminal 2′ by migrating through the wireless CDMA network, the handoff legs 8 and 8″ maintain a plurality of diverse communication channels between the mobile terminal and the base station network as handoff leg 8′ is dropped and handoff leg 8′″ is added.

For both the prior art continuous soft handoff method and the discrete soft handoff method of the present invention, a plurality of handoff legs are reserved for soft handoff of a mobile terminal. Thus, in order to perform soft handoff of mobile terminal 2 under both the prior art method and the present invention, the plurality of handoff legs 8 and 8′ are reserved to communicate information between the mobile terminal 2 and the base stations 4 and 4′, respectively. Similarly, to perform soft handoff of a second mobile terminal 2′ under both the prior art method and the present invention, the plurality of handoff legs 8″ and 8′″ are reserved to communicate information between the mobile terminal 2′ and the base stations 4 and 4″, respectively.

The prior art method and the present invention differ, however, in the use of these reserved channels for the actual transmission of any particular CDMA data frame. Under the prior art method, the wireless CDMA network will communicate every CDMA data frame with the mobile terminal 2 via all four of its handoff legs 8 and 8′, regardless of the relative signal strength of the handoff legs 8 and 8′ for any particular CDMA data frame transmission. Thus, although there may be an obstruction, high loading, or other factors that would make one or more of the handoff legs 8 and 8′ ineffective for a particular CDMA data frame transmission relative to the other handoff legs, the CDMA data frame will nonetheless be transmitted via all four handoff legs 8 and 8′.

Soft handoff by transmission of a CDMA data frame via a comparatively ineffective or weak handoff leg from the total set of handoff legs 8 and 8′ thereby results in unnecessary interference to other mobile terminals, power and resource consumption and complexity without any real benefit. This is so because the advantages of signal diversity are marginalized due to the fact that the CDMA data frame received via weak data channels will not be selected as the best CDMA data frame, and it will not significantly contribute to the aggregate best CDMA data frame. In other words, the strong handoff legs dominate the weak handoff legs when selection or aggregation occurs, such that no real benefit is realized by performing soft handoff of the mobile terminal 2 via every handoff leg 8 and 8′ regardless of their channel strength. Instead, it is desirable to identify only those strong handoff legs from the total reserved set of handoff legs 8 and 8′ for any particular CDMA data frame transmission. Soft handoff then occurs when each CDMA data frame is transmitted via one or more of the strong handoff legs from the reserved handoff legs 8 and 8′ that are dedicated to soft handoff of the mobile terminal 2.

The present invention performs precisely this function by predicting which of the handoff legs from the total reserved set of handoff legs will be strong handoff legs, and then actively transmitting CDMA data frames via at least one of the strong handoff legs. In one illustrative embodiment of the invention the prediction and decision making are done by a software process that resides on the MSC 12. The mobile terminal communicates the received signal attributes (received signal strength, SIR, etc.) to the MSC. The MSC then, in turn, predicts the quality of the handoff legs given the mobile terminal information and decides which handoff legs will be used for forward link transmissions. In a second illustrative embodiment of the invention the mobile terminal both collects signal attributes, processes them on a regular basis, and performs the predictive analysis. The mobile terminal would then communicate the set of desired handoff legs to be used for transmission to the MSC 12. This keeps the processing on the mobile terminal and eliminates the need to make frequent updates to the MSC. Both embodiments require that this information be sent in a proper protocol so that both parties would be able to parse and properly format these messages. Furthermore both embodiments have a notion of time-cycles and a semi-regular exchange between the mobile terminal and the MSC as well as a notion of how long a particular predication is good for. For instance the mobile terminal and MSC may communicate these values very frequently, like on the order of every packet, and consequently the prediction will be very current. Alternatively, the mobile terminal and the MSC may decide to communicate these values less frequently and rely on the prediction to be relevant for a longer period of time. For instance, the mobile terminal 2 has reserved four handoff legs 8 and 8′ between the mobile terminal 2 and the base stations 4 and 4′, respectively. Although all four handoff legs 8 and 8′ are reserved for soft handoff of the mobile terminal 2, each individual handoff leg may be strong or weak for each CDMA data frame transmission depending on various factors such as transmission and reception signal strength, distance, loading and obstructions. In such a case, soft handoff should occur only via transmission over at least one strong handoff leg, because transmission over the weak handoff legs within the reserved set of handoff legs 8 and 8′ provides no significant benefit or signal diversity, but does increase power consumption and interference in the system.

For example, a physical obstruction, loading, or other factors may affect the handoff leg 8′ to the extent that this leg is predictably weak relative to the other three handoff legs 8 for a particular CDMA data frame transmission. Thus, the active set of handoff legs used to handoff the mobile terminal 2 will include at least one of the strong handoff legs 8. Transmitting the CDMA data frame via the weak handoff leg 8′ merely increases power consumption at no additional benefit. Once whatever obstruction, loading, or other factor making handoff leg 8′ weak is removed, this leg may become a strong handoff leg and thereby be included in the active set of handoff legs used to transmit a CDMA data frame.

Similarly, mobile terminal 2 may in fact be closer to base station 4′ than the other three base stations 4. Thus, handoff leg 8′ may be significantly stronger than the other three handoff legs 8, and the active set of handoff legs used to transmit CDMA data frames may include only the handoff leg 8′. The other three handoff legs 8 nonetheless remain reserved for soft handoff in case an obstruction, loading, or other factor causes the handoff leg 8′ to become weak relative to the other three handoff legs 8. In that case, at least one of the three handoff legs 8 would join the active set of handoff legs used to transmit the CDMA data frames, whereas the handoff leg 8′ may be removed from the active set.

In this way, the present invention performs soft handoff of a mobile terminal by reserving a set of handoff legs used to handoff a mobile terminal. The present invention predicts which of the handoff legs within the reserved set are strong, and which of the handoff legs within the reserved set are weak, for each CDMA data frame transmission. The present invention then performs soft handoff by placing at least one of the strong handoff legs within the active set of handoff legs used to communicate CDMA data frames. As the relative strength of the handoff legs changes, those handoff legs from the reserved set that become strong may be added to the active set of handoff legs used to perform soft handoff, whereas those handoff legs from the active set that become weak may be removed from the active set of handoff legs used to perform soft handoff.

While not further described herein, the base terminals, mobile stations, and mobile switching center advantageously include processors for performing the requisite actions both for wireless transmission and for handoff operations, as is known in the art. Depending on the specific wireless network and in accordance with the specific illustrative embodiments herein described, the processing steps for carrying out the present invention may be undertaken by a processor in the a mobile terminal, a processor in a base station, or a processor in the mobile switching center. Further, the processor involved advantageously includes the databases, stores, and other software controlled operations as is known in the art and as would be utilized in practicing the methods of the present invention.

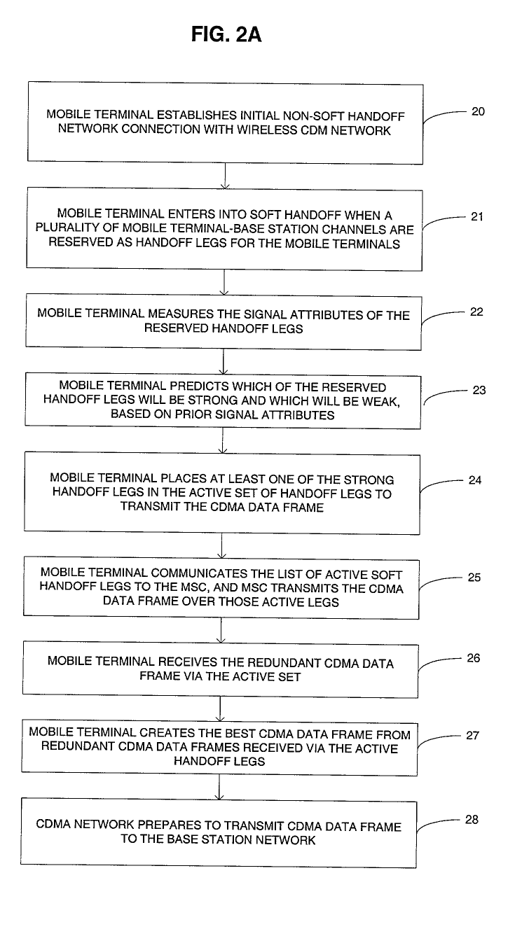

FIGS. 2A and 2B are flow charts of the discrete soft handoff process according to the present invention for two illustrative embodiments thereof, the first being where the mobile terminal does the prediction process and tells the MSC which handoff legs to use and the second being where the mobile terminal reports the signal attributes to the MSC and the MSC processes them and determines the appropriate handoff legs to use. Steps common to both embodiments are identified in FIGS. 2A and 2B by the same reference number.

Referring now to FIGS. 2A and 2B, the mobile terminal first establishes a non-soft-handoff network connection with the wireless CDMA network in step 20. The mobile terminal then enters into soft handoff with the wireless CDMA network when a plurality of mobile terminal-base station communication channels are reserved as handoff legs dedicated to support the soft handoff of the mobile terminal in step 21. This reservation step is identical to the reservation step that occurs in prior art, continuous soft handoff methods wherein a plurality of communication channels are reserved for soft handoff of a mobile terminal.

Continuing with the embodiment depicted by the flowchart of FIG. 2A, after the plurality of handoff legs has been reserved to support soft handoff of the mobile terminal, the mobile terminal, step 22, measures the signal attributes of the reserved handoff leg and then predicts, step 23, which of the reserved handoff legs will be strong and which of the handoff legs will be weak, based on the prior signal attributes. Then the mobile terminal places at least one of the strong handoff legs in the active set of handoff legs, step 24, used to transmit the CDMA data frame. The mobile terminal then communicates the list of active soft handoff legs to the MSC which in turn transmits the CDMA dataframe over those active legs, step 25. The mobile terminal receives, step 26, these dataframes and then creates, step 27, the best CDMA dataframe from the redundant dataframes received, as by aggregation, selection, or other appropriate methods. Having created this best dataframe, the CDMA network is then in position to prepare to transmit the CDMA dataframe to the base station network, step 28.

In order to communicate the CDMA data frame, the mobile terminal first measures the signal strength of the reserved handoff legs based on signals received from the base stations that correspond to the reserved handoff legs in step 22. The mobile terminal then predicts which of the reserved handoff legs from the plurality of handoff legs within the reserved set will be strong, and which of the reserved handoff legs from the plurality of handoff legs will be weak, based on factors including the prior signal strength measurements for the handoff legs in step 23. The mobile terminal moves at least one of the strong handoff legs from the reserved set to the active set of handoff legs that will be used to communicate the CDMA data frame in step 24. The actual number of strong handoff legs moved to the active set will vary based on the specific implementation and configuration information. For instance, in architectures wherein no selection or aggregation of received CDMA data frames is used to perform soft handoff, then only one strong handoff leg can be included in the active set. In contrast, where selection or aggregation of received CDMA data frames is used to perform soft handoff, then the number of strong handoff legs moved into the active set will depend on factors including the specific network architecture, power consumption, and general configuration information for the network.

In order to transmit a CDMA data frame from mobile terminal to the base station network, a mobile terminal places at least one of its reserved handoff legs in the active set for a CDMA data frame transmission, and transmits the CDMA data frame. Since each base station associated with the mobile terminal through reserved handoff legs is aware of the unique mobile terminal channel code, each base station is able to decode the mobile terminal's transmitted packet. In this embodiment, referred to as “discrete soft handoff via selective forwarding”, the active set of handoff legs still indicates which handoff legs are the best handoff legs for CDMA data frame transmission, and thereby indicates which CDMA data frames should be used for aggregation and/or selection. However, for discrete soft handoff via selective forwarding, the recipient base stations selectively forward only those CDMA data frames received via active handoff legs, even though the CDMA data frame is received by each base station communicating with the mobile terminal using their respective handoff leg. Thus, in this embodiment only base stations that are associated with active handoff legs will forward their received CDMA data frames which are to be aggregated and/or selected after reception, rather than every base station associated with the reserved handoff legs. Mobile terminals notify base stations regarding which handoff legs are in the active set by including active set information in each CDMA data frame transmitted to each base station. This active set information indicates whether the handoff leg that carried the CDMA data frame is in the active set, and thereby indicates whether the base station should forward the CDMA data frame for aggregation and/or selection. In particular, each CDMA data frame includes a Serving Base Station field, which specifies if the handoff leg used to communicate the CDMA data frame is within the active set. The recipient base station examines the Serving Base Station field to determine if the handoff leg which communicated the CDMA data frame is in the active set. If so, then the recipient base station forwards the CDMA data frame for aggregation and/or selection; if not, then the recipient base station does not forward the CDMA data frame for aggregation and/or selection.

With discrete soft handoff via selective forwarding, although soft handoff occurs via transmission over all handoff legs, the soft handoff of the mobile terminal remains discrete because only those CDMA data frames transmitted over handoff legs included in the active set are aggregated and/or selected. As a result, only those CDMA data frames communicated via soft handoff legs within the active set are aggregated and/or selected to create a “best” CDMA data frame, even though each base station communicating with the mobile terminal receives a CDMA data frame from the mobile terminal. Furthermore, those forwarded CDMA data frames are the CDMA data frames that are transmitted over strong handoff legs as determined by the mobile terminal. Thus, aggregation and/or selection includes CDMA data frames transmitted using strong handoff legs while excluding CDMA data frames transmitted using weak handoff legs, thereby providing the benefits of the present invention.

Referring again to FIG. 1, discrete soft handoff via selective forwarding is shown for mobile terminal 2, which is in discrete soft handoff with base stations 4 and 4′. Mobile terminal 2 determines that handoff leg 8′ for base station 4′ is a strong handoff leg, whereas handoff legs 8 for base stations 4 are weak handoff legs. Thus, mobile terminal 2 includes handoff leg 4′ in the active set of handoff legs for soft handoff, while excluding handoff legs 4 from the active set. As a result, the Serving Base Station field is set for the CDMA data frame to be transmitted over handoff leg 8′ to base station 4′, but is not set for t he CDMA data frames to be transmitted over handoff legs 8 to base stations 4.

Mobile terminal 2 next transmits the CDMA data frame and is received on all four handoff legs 8 and 8′ even though only handoff leg 8′ is included in the active set. Base stations 4 and 4′ receive their respective CDMA data frame and examine the Serving Base Station field to determine if the CDMA data frames' corresponding handoff legs 8 and 8′ are within the active set. Base station 8′ determines that the Serving Base Station field for its received CDMA frame data is set, and thus handoff leg 8′ that communicated the received CDMA data frame is an active handoff leg. Base station 8′ then forwards its received CDMA data frame to the wireless IP backbone network 6 for aggregation and/or selection. Similarly, the base stations 4 determine that the Serving Base Station field for their respective received CDMA data frames are not set, and thus handoff legs 8 that communicated the received CDMA data frames are not active handoff legs. As a result, the base stations 4 do not forward their received CDMA data frames to the wireless IP backbone network 6 for aggregation and/or selection.

If subsequent CDMA data frames received by base stations 4 and 4′ indicate that their corresponding soft handoff legs 8 and 8′ have been added to or removed from the active set, then base stations 4 and 4′ will forward or cease forwarding, respectively, their received CDMA data frames to the wireless IP backbone network 6 for aggregation and/or selection. Thus, base stations 4 may subsequently receive CDMA data frames whose Serving Base Station fields are set, in which case the base stations 4 will forward their received CDMA data frames. Similarly, base station 4′ may subsequently receive CDMA data frames whose Serving Base Station fields are not set, in which case base station 4′ will not forward its received CDMA data frames.

In the embodiment wherein the processing is done at the MSC, the present invention, as depicted in FIG. 2B, again starts with steps 20, 21, and 22 wherein the mobile terminal establishes the initial connection, enters into the soft handoff mode, and measures the signal attributes of the reserved handoff legs. In this embodiment however, the mobile terminal next, step 30, communicates the collected signal attributes to the MSC in the CDMA network, and the MSC does the processing, step 31, to determine the strong and weak soft handoff legs. After the CDMA network prepares to transmit the CDMA data frame to the mobile terminal, step 32, the dataframe is transmitted from the MSC over the handoff legs in the active set, step 33. As with the prior embodiment, the mobile terminal receives the redundant CDMA data frames via the active handoff legs, step 26, and creates the best CDMA data frame from the redundant data frames received, as by aggregation, selection, or other appropriate methods, step 27. The CDMA network then prepares to transmit the best CDMA dataframe to the base station network, step 28.

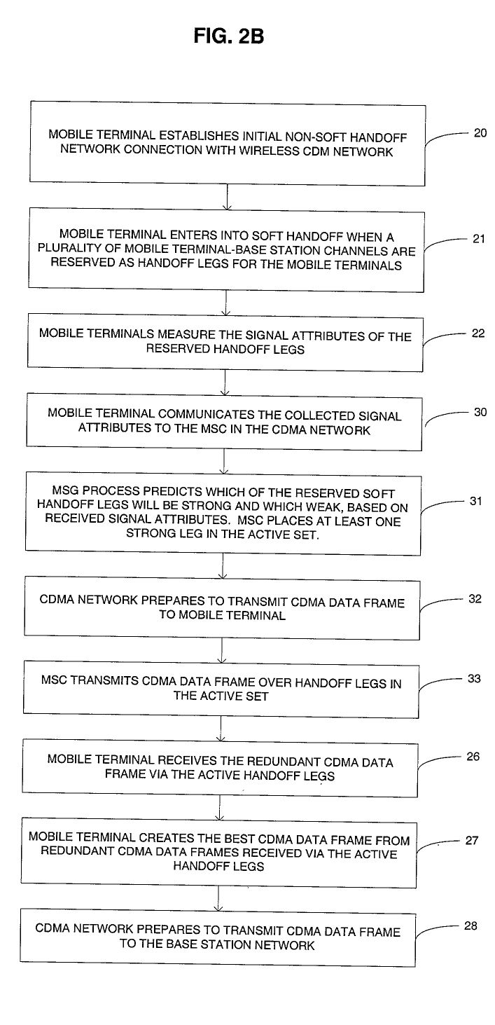

FIG. 3 shows a flowchart of the handoff leg signal strength measurement process, wherein the mobile terminal determines the signal quality and strength of a handoff leg between the mobile terminal and the base station. The signal quality and strength of the handoff leg are then used to predict the future quality and strength of the handoff leg between a mobile terminal and a base station. The handoff leg signal strength measurement process is performed on each of the plurality of reserved handoff legs between the mobile terminal and a single base station as described in step 22 of the discrete soft handoff process shown in FIG. 2A. Thus, when applied to each of the reserved handoff legs between the mobile terminal and the plurality of base stations, the handoff leg signal strength measurement process creates a history of the signal quality and strength of each reserved handoff leg over a period of time.

As is known each base station transmits a continuous beacon type pilot signal to the mobile terminal, which signal includes identification information for the base station. Each CDMA pilot signal acts as a constant beacon signal that is transmitted by its respective base station, and the properties of each CDMA pilot signal are known to the mobile transmitter. Thus, the mobile transmitter knows the baseline properties of the CDMA pilot signal transmitted from the base station to the mobile terminal.

The mobile terminal receives the CDMA pilot signal, which includes identification information about its transmitter base station in step 42, and the mobile terminal determines the identity of the base station that transmitted the CDMA pilot signal based on the identification information included within the CDMA pilot signal in step 44. The mobile terminal then determines in step 46 how much degradation has occurred to the signal by comparing the strength and quality of the received CDMA pilot signal to the CDMA pilot signal's known baseline signal strength and quality. The mobile terminal also determines in step 48 the quality of the received CDMA pilot signal by determining the signal-to-interference ratio for the CDMA pilot signal received from the base station.

After determining the CDMA pilot signal degradation in step 46 and signal-to-interference ratio in step 48, the calculated CDMA pilot signal degradation and signal-to-interference values are recorded in a CDMA pilot signal history database in step 50. Because the CDMA pilot signal is a well known signal the mobile terminal can determine the signal degradation and for, a given period of observation, the number of bit errors. So the mobile terminal can determine the Bit Error Rate (BER), the received signal strength, and the signal to interference ratio. These are among the signal attributes that the mobile terminal has available to it. Each received CDMA pilot signal has its own individual CDMA pilot signal history database, and thus the signal strength for each handoff leg and its corresponding base station is recorded for the particular time when the CDMA pilot signal was received.

The process of FIG. 3 can be iterative so that the mobile terminal can determine the signal degradation and signal-to-interference ratio for a later-received CDMA pilot signal in step 46 and step 48, respectively, and the mobile terminal then records the signal degradation and signal-to-interference ratio values for the later-received CDMA pilot signal in the CDMA pilot signal history database in step 50. Thus, the soft handoff signal strength measurement process creates a history of CDMA pilot signal strength values that includes the degradation and signal-to-interference ratio values for the CDMA pilot, and thereby its corresponding handoff leg and base station, over a period of time.

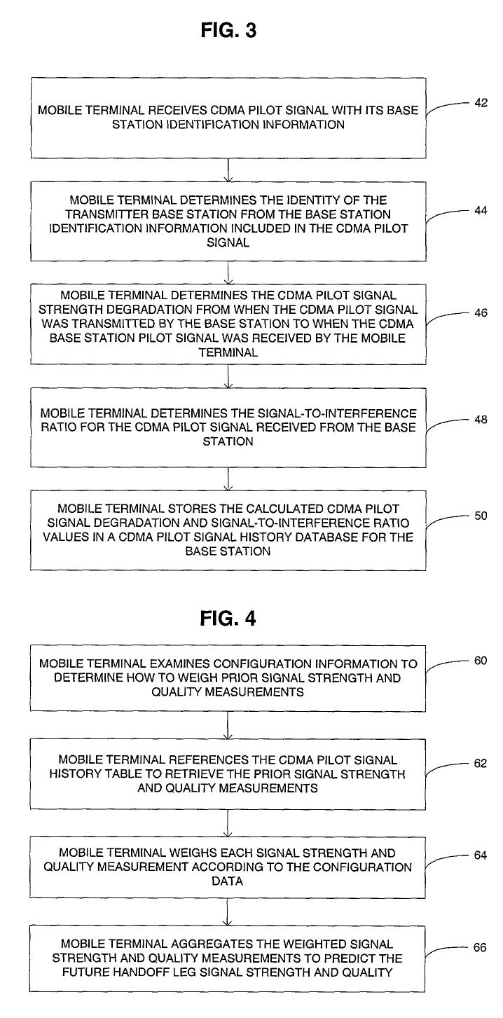

FIG. 4 is a flowchart of the handoff leg signal strength prediction process for the first embodiment, wherein a mobile terminal predicts the future signal strength and quality for a single handoff leg between a mobile terminal and a base station. The handoff leg signal strength prediction process references the CDMA pilot signal history database for the particular handoff leg and its respective base station to predict the future strength and quality of the handoff leg between the base station and the mobile terminal. The handoff leg signal strength prediction process is performed on each of the plurality of reserved handoff legs between a mobile terminal and the plurality of base stations as described in step 23 of the discrete soft handoff process shown in FIG. 2A. Thus, when applied to each of the reserved handoff legs between the mobile terminal and the plurality of base stations, the handoff leg signal strength prediction process predicts the future strength and quality of each reserved handoff leg.

It should be understood that the handoff leg signal strength prediction process assumes that the mobile terminal has already established communication between itself and the base station for the handoff leg whose strength and quality is being predicted by the handoff leg signal strength prediction process. Thus, the handoff leg between the mobile terminal and the base station, along with its associated CDMA pilot signal history database, already exists, and the CDMA pilot signal history database may be referenced as the handoff leg signal strength prediction process occurs.

It should also be understood that the CDMA pilot signal history database is constantly updated with new values as the handoff leg signal strength prediction process occurs over time. Thus, as the values of the CDMA pilot signal history database are updated to reflect more recent CDMA pilot signal strength and quality measurements, the predictions of the future handoff leg signal strength and quality will also change (as it should) to reflect the more recent measurements of the CDMA pilot signal strength and their effect on the future handoff signal strength and quality predictions.

Turning now to FIG. 4, the mobile terminal in step 60 first references configuration information that instructs the mobile terminal how to weight prior signal strength and quality measurements. In general, earlier measurements will be given less weight, whereas more recent measurements will be given greater weight. The mobile terminal then accesses the CDMA pilot signal history database to retrieve prior signal strength and quality measurements for the CDMA pilot signal associated with the base station for the handoff leg in question, including prior measurements of the CDMA pilot signal strength degradation and signal-to-interference measurements in step 62. The mobile terminal multiplies these prior signal strength and quality measurements for the CDMA pilot signal by the appropriate weighting factor as specified by the configuration information, thereby weighting the prior signal strength and quality measurements in step 64. Finally, the mobile terminal in step 66 aggregates the weighted prior signal strength and quality measurements to create a predicted signal strength, and quality value for the handoff leg based on the past handoff leg signal strength and quality observations. Strong handoff legs are those legs with a high predicted signal strength and quality value, whereas weak handoff legs are those handoff legs with a low predicted signal strength and quality value.

As this process occurs, the CDMA pilot tone signal strength and quality measurements recorded in the CDMA pilot signal history database are updated and supplemented based on more recent measurements of the CDMA pilot signal for the handoff leg. Thus, the process returns to step 62 and is repeated to determine more recent and accurate handoff leg signal strength and quality value predictions based on the updated and supplemented CDMA pilot signal history database. In the interim, the predicted signal strength and quality value for the handoff leg determined at step 66 is used as the basis for comparison when determining whether the handoff leg should go into the active set. The predicted signal strength and quality value determined at step 66 remains the current basis until it is superceded by a more recent and accurate handoff leg signal strength prediction based on the updated and supplemented CDMA pilot signal history database.

In order to determine which handoff legs are selected for the active set of handoff legs, the predicted signal strength and quality value for the handoff leg produced at step 66 is compared to other predicted signal strength and quality values for other handoff legs. This comparison and selection process is shown in step 24 of the discrete soft handoff process shown in FIG. 2A, wherein at least one of the strong handoff legs is placed in the active set of handoff legs used to transmit a CDMA data frame. In particular, those handoff legs with the highest predicted signal strength and quality values are included in the active set of handoff legs; thus, the active set of handoff legs includes those handoff legs with the highest probability of having the highest strength and highest quality communication signal between the mobile terminal and the base station network.

Selection of the number of handoff legs included in the active set based on the predicted handoff leg signal strength is also based on configuration information within the mobile terminal. For instance, a mobile terminal or base station network may be configured to include only the single strongest handoff leg within the active set, thereby communicating CDMA data frames using only one handoff leg. In the alternative, different signal strength thresholds may be set, and all handoff legs whose predicted signal strengths are above those thresholds may be included in the active set. In addition, a minimum signal strength threshold may be set, wherein if no handoff leg has a predicted signal above the minimum threshold signal strength, then the mobile terminal communicates in the prior art soft handoff fashion until at least one handoff leg has a predicted signal strength above the minimum threshold value. In this fashion, the present invention can ensure that if all the handoff legs are relatively weak, then all soft handoff legs are used to communicate CDMA data frames.

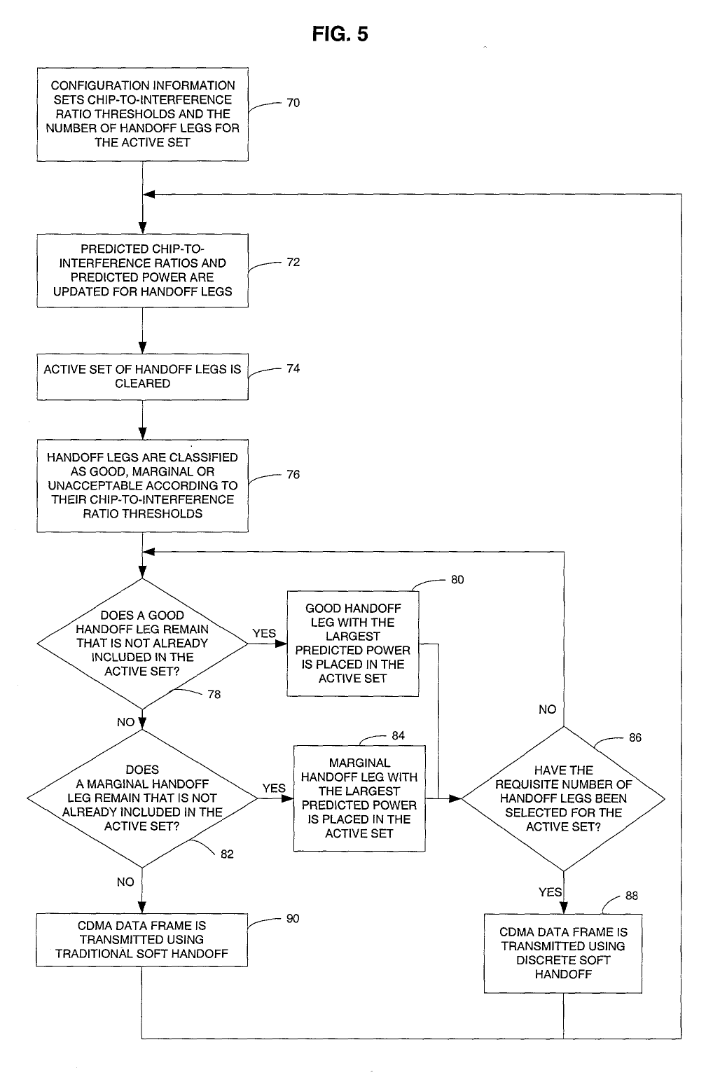

One embodiment that illustrates the selection of at least one soft handoff leg for inclusion in the active set for the embodiment where the predictive processing is done at the mobile terminal is shown by the handoff leg active set selection process shown in FIG. 5. The handoff leg active set selection process assumes that the handoff leg signal strength measurement and handoff leg signal strength prediction processes have been performed, and thus there exists a record that includes signal strength predictions for a plurality of handoff legs based on prior signal strength measurements.

The handoff leg active set selection process assumes that the handoff leg signal strength measurement process shown in FIG. 3 has determined the received power (Rx) and received chip-energy-to-interference ratio (Ec/Io) for a plurality of handoff legs and their associated CDMA data frame transmissions. The received power is the measurement of the received signal strength for a CDMA data frame transmission, whereas the chip-to-energy interference ratio is the measurement of the strength of the received CDMA signal to the noise in the CDMA signal. The chip-to-energy interference ratio can be directly mapped to the predicted probability error for transmission, whereas the received power indicates the distance between a base station and a mobile terminal. There are well accepted formulas that can determine the expected quality of a transmission for a CDMA system given the chip-to-energy ratio and some other standard fixed system parameters. However these formulas can be reduced to prove that signal quality is proportional to chip-to-energy ratio. Therefore high chip-to-energy ratios will yield higher signal qualities. Signal quality in this context is the probability that a packet will be received without errors.

The handoff leg active set selection process also assumes that the handoff leg signal strength prediction process shown in FIG. 4 has weighted the chip-energy-to-interference ratio and received power measurements to create a predicted chip-energy-to-interference ratio and power measurement for each handoff leg. Thus, for a plurality of handoff legs from which handoff legs in the active set are selected, a single chip-energy-to-interference ratio prediction and power prediction exists and is used as the basis to select handoff legs for the active set.

As shown by the handoff leg active set selection process shown in FIG. 5, in step 70 configuration information is first included that specifies different chip-to-interference ratio thresholds, as well as the number of handoff legs to be included in the active set. For instance, a “marginal threshold” and a “good threshold” can be specified, wherein the good threshold is higher than the marginal threshold. Thus, handoff legs can be classified as good, marginal or unsatisfactory based on their predicted chip-to-interference ratios.

At step 72, the predicted chip-to-interference and power ratios for the handoff legs are updated prior to creating a new set of active handoff legs. The active set of handoff legs is then cleared to create a new set of active handoff legs for the updated predicted soft handoff legs in step 74, and the updated handoff legs are classified as good, marginal or unsatisfactory according to their predicted chip-to-interference ratios in step 76. Thus, handoff legs with predicted chip-to-interference ratios that are below both the marginal and good thresholds are classified as “unsatisfactory,” handoff legs with predicted chip-to-interference ratios that are above the marginal threshold but below the good threshold are classified as “marginal,” and handoff legs with predicted chip-to-interference ratios that are above both the marginal and good thresholds are classified as “good.”

The handoff legs are then selected for the active set according to their classification as good, marginal or poor based on their predicted chip-to-interference ratio, as well as according to their predicted power. First, it is determined if there is at least one good handoff leg not already included in the active set in step 78. If not, then there are no good remaining handoff legs, so the process proceeds to step 82; if so, then at least one good handoff leg remains that is not in the active set, and the process proceeds to step 80.

At step 80, the next handoff leg for the active set is selected from those remaining good handoff legs by selecting the good handoff leg with the highest predicted power. In the event that the highest predicted power is the same for more than one remaining good handoff leg, then one these equally good handoff legs is randomly selected for inclusion in the active set. Thus, the good handoff leg with the highest predicted power is selected and included in the active set of handoff legs in step 80, and the process proceeds to step 86.

At step 82, it has been determined that no good handoff legs remain that can be included in the active set. Thus, it is determined if there is at least one marginal handoff leg not already included in the active set in step 82. If not, then there are no marginal remaining handoff legs so the process proceeds to step 90; if so, then at least one marginal handoff leg remains that is not in the active set, and the process proceeds to step 84.

At step 84, the next handoff leg for the active set is selected from those remaining marginal handoff legs by selecting the marginal handoff leg with the highest predicted power. In the event that the highest predicted power is the same for more than one remaining marginal handoff leg, then one these equally marginal handoff legs is randomly selected for inclusion in the active set. Thus, the marginal handoff leg with the highest predicted power is selected and included in the active set of handoff legs in step 84, and the process proceeds to step 86.

At step 86, either a good or a marginal handoff leg has been selected for and included in the active set. It is then determined in step 86 if the requisite number of handoff legs have been selected for the active set by determining whether the number of handoff legs in the active set is equal to the number of handoff legs to be included in the active set according to the configuration information. If so, then the appropriate number of handoff legs has been selected for the active set, so the process proceeds to step 88, wherein the CDMA data frame is communicated using discrete soft handoff via the handoff legs in the active set. If not, then the process returns to step 78, and another handoff leg is selected for inclusion in the active set.

At step 90, neither any good nor any marginal handoff legs remain for inclusion in the active set. Thus, the requisite number of quality handoff legs are not present for discrete soft handoff, and the CDMA data frame is communicated using the prior art, non-discrete soft handoff method in step 90, and the process returns to step 72 to seek another handoff log for inclusion in the active set.

At steps 86 and 88, the CDMA data frame has been transmitted using either discrete soft handoff or prior art soft handoff, respectively, based on whether enough good or marginal quality handoff legs exist for inclusion in the active set. Thus, after both steps 86 and 88, the process returns to step 72, and a new active set of handoff legs is created for transmission of the next CDMA data frame. Thus, the predicted chip-to-interference and power ratios for the handoff legs are updated in step 72 and the active set of handoff legs is cleared in step 74 to prepare for the next CDMA data frame transmission. The handoff legs are then reclassified as good, marginal or unacceptable according to their updated predicted chip-to-interference ratios and predicted powers in step 76, and selection of the first handoff leg of the next new active set begins again by proceeding to step 78.

While FIGS. 3, 4, and 5 depict flow charts for processes specifically for the embodiment wherein the mobile terminal does the prediction processing, similar flow charts will be readily apparent to those of skill in the art with respect to the embodiment of FIG. 2B wherein the mobile switching center does the prediction processing and the determination of appropriate handoff legs to use.

While the invention has been particularly shown and described with reference to preferred embodiments thereof, it will be understood by those skilled in the art that various changes in form and details may be made therein without departing from the spirit and scope of the invention.

We claim:

1. A method for effecting a soft handoff in a wireless communications network between a mobile terminal and a plurality of base stations wherein there are a plurality of handoff legs reserved for communication between said mobile terminal and said base stations, said method comprising the steps of:
predicting which of said reserved handoff legs will be a strong channel for the handoff transmission between the mobile terminal and one of said base stations; and
transmitting a wireless communication dataframe over only one or more of said predicted strong channel hand-off legs.

2. The method in accordance with claim 1 wherein said predicting step includes the step of measuring one or more signal attributes in each of said reserved channels.

3. The method in accordance with claim 2 wherein one of said signal attributes is signal strength.

4. The method in accordance with claim 2 further comprising the steps of the mobile station receiving wireless communication data frames over a plurality of predicted strong channel handoff legs and creating the best data frame from the data frames received over said plurality of handoff legs.

5. The method in accordance with claim 4 wherein said step of creating comprises selecting a particular dataframe.

6. The method in accordance with claim 4 wherein said step of creating comprises aggregating said received dataframes.

7. The method in accordance with claim 1 wherein said wireless communication dataframe is CDMA dataframe.

8. The method in accordance with claim 1 further comprising the steps of:
a base station transmitting to the mobile station a pilot signal that includes identification information of the base station;
the mobile terminal determining the pilot signal strength degradation from when the pilot signal was transmitted by the base station to when the base station pilot signal was received by the mobile station;
determining at the mobile station the signal-to-interference ratio for the pilot signal received from the base station; and
storing at the mobile station calculated pilot signal degradation and signal-to-interference ratio values in a pilot signal history database for the base station.

9. The method in accordance with claim 1 wherein said predicting step includes the mobile station making signal strength and quality measurements and storing said measurements.

10. The method in accordance with claim 1 wherein said predicting step includes the steps of:
setting chip-to-interference ratio threshold for the handoff legs and
classifying the handoff legs as good, marginal, or unacceptable according to said thresholds.

11. The method in accordance with claim 1 wherein said predicting step includes the mobile terminal measuring a plurality of signal attributes of the reserved handoff legs.

12. The method in accordance with claim 11 wherein, based on said measured signal attributes, said predicting step is further performed in the mobile terminal.

13. The method in accordance with claim 11 wherein the wireless communication network also includes a mobile switching center and said predicting step further comprises
the mobile terminal communicating the measured signal attributes to the mobile switching center, and
said mobile switching center then completing said predicting step.

14. The method in accordance with claim 1 wherein said predicting step is performed at the mobile terminal.

15. The method in accordance with claim 1, wherein said predicting step comprise predicting which of said reserved handoff legs would be strong channels and which of said reserved handoff legs would be weak channels.

16. A method for implementing a discrete soft handoff between a mobile terminal and a base station in a wireless telecommunications network, said method comprising the steps of:
establishing a set of reserved handoff legs for transmitting CDMA data frames between a base station and a mobile terminal;
measuring the signal strengths of signals in each handoff leg;
predicting the signal strengths of signals for each handoff leg based on said measured signal strengths; and
determining that at least one of the handoff legs should be an active handoff leg, said active handoff leg meeting a threshold signal strength level as determined based upon said predicting step; and
transmitting the CDMA dataframes from the mobile terminal to the base station over said active handoff leg.

17. A method for effecting a soft handoff in a wireless communication network comprising mobile terminals, base terminals, and a mobile switching center, said method comprising the steps of:
a mobile terminal measuring signal attributes of reserved handoff legs in the network,
the mobile terminal, based on the measured signal attributes, predicting which of the handoff legs will be a strong handoff leg and placing at least one predicted strong handoff leg in a set of reserved active handoff legs;
the mobile terminal communicating to the mobile switching center the identity of the set of reserved active handoff legs and receiving CDMA data frames communicated from the mobile switching center; and
the mobile terminal creating the best CDMA dataframe from redundant CDMA data frames received from the mobile switching center.

18. The method in accordance with claim 15 wherein the mobile switching center communicates the CDMA dataframes to the mobile terminal through one or more base stations, but only those base stations that are associated with a reserved active handoff-off leg forward the CDMA dataframes to the mobile terminal.

19. A method for effecting soft handoff in a wireless communication network comprising mobile terminals, base stations, and a mobile switching center, said method comprising the steps of:
a mobile terminal measuring signal attributes of reserved handoff legs in the network;
the mobile terminal communicating the collected signal attributes to the mobile switching center;
the mobile switching center, based on the measured signal attributes, predicting which of the reserved handoff legs will be a strong handoff leg and placing at least one predicted strong handoff leg in a set of reserved active handoff legs;
the mobile switching center communicating to the mobile terminal CDMA dataframes over the handoff leg in the active set; and
the mobile terminal creating the best CDMA dataframe from redundant CDMA dataframes received from the mobile switching center.

20. The method according to claim 19 wherein the mobile switching center communicates the CDMA dataframes to the mobile terminal through one or more of the base stations, but only those base stations that are associated with a reserved active handoff leg forward the CDMA dataframes to the mobile station.
